(19) United States
(12) Patent Application Publication
(10) Pub. No.: US 2010/0213707 A1
(43) Pub. Date: Aug. 26, 2010

(54) THREADED CONNECTION FOR A FLUID FLOW APPARATUS

(76) Inventor: Damon Drumm, St. Louis, MO (US)

Correspondence Address: HARNESS, DICKEY, & PIERCE, P.L.C, 7700 Bonhomme, Suite 400, ST. LOUIS, MO, 63105, US

(21) Appl. No.: 12/774,137

(22) Filed: May 5, 2010

(51) Int. Cl. F16L 15/00

(52) U.S. Cl. 285/390

(57) ABSTRACT

A fluid flow apparatus is provided that is configured to receive a threaded fitting in a manner so as to align with an internally threaded hole in the apparatus to avoid cross-threading. The fluid flow apparatus includes a body having an outer surface, and an internally threaded hole in the outer surface. The internally threaded hole may have a number of start threads with an associated thread lead distance. The fluid flow apparatus includes at least two slots in the outer surface, where the slots extend to and intersect the internally threaded hole in the outer surface. The at least two slots have a depth from the outer surface that is more than ½ the thread lead distance but less than 1½ times the thread lead distance, such that for each start thread only a first coil of the start thread has a full threadform cross-section that is exposed by the slots.

### FIELD

The present disclosure relates to various fluid flow devices, and more specifically to the connection of threaded fittings to various fluid flow devices.

### BACKGROUND

This section provides background information related to the present disclosure which is not necessarily prior art.

Many fluid flow apparatus or valves are adapted to be connected to small diameter fittings or pipelines via threaded joints, for communication of gas, water or other fluids therethrough. Because pipe joints or threaded fittings typically have tapered pipe threads, such threaded fittings can easily become cross-threaded if the threaded opening in the fluid flow device and the threaded fitting are not properly aligned with each other.

### SUMMARY

This section provides a general summary of the disclosure, and is not a comprehensive disclosure of its full scope or all of its features.

Various embodiments of a fluid flow apparatus are disclosed that are configured to receive a threaded fitting in a manner such that the mating threaded fitting aligns with an internally threaded hole in the apparatus so that cross-threading is avoided. In one embodiment, a fluid flow apparatus includes a housing or body having an outer surface, and an internally threaded hole in the outer surface of the body. The internally threaded hole may have a number of start threads with an associated thread lead distance. The fluid flow apparatus further includes at least two slots in the outer surface of the body, where the slots extend to and intersect the internally threaded hole in the outer surface of the body. The at least two slots have a depth from the outer surface that is more than ½ the thread lead distance but less than 1½ times the thread lead distance, such that for each start thread only a first coil (or wrap, turn, revolution, etc.) of the start thread has a full threadform cross-section that is exposed by the slots. Accordingly, the depth of the at least two slots create only one fully exposed threadform that provides a lead-in notch configured to enable a mating threaded fitting to align with the internally threaded hole, to more effectively avoid cross-threading.

Further areas of applicability will become apparent from the description of the various embodiments provided herein. The description and specific examples in this summary are intended for purposes of illustration only, and are not intended to limit the scope of the present disclosure to the specific embodiments described.

### DRAWINGS

The drawings described herein are for illustrative purposes only of selected embodiments and not all possible implementations, and are not intended to limit the scope of the present disclosure.

FIG. 1 is a perspective view of one embodiment of a fluid flow apparatus including a threaded hole and at least two slots, in accordance with the principles of the present application;

FIG. 2 is a perspective view of a second embodiment of a fluid flow apparatus including a threaded hole and at least two slots;

FIG. 3 shows a perspective view of a third embodiment of a fluid flow apparatus including a threaded hole and at least two slots, in accordance with the principles of the present application; and

FIG. 4 shows a top elevation view and side elevation view of a fourth embodiment of a fluid flow apparatus, which includes a threaded hole and at least two slots in accordance with the principles of the present application.

Corresponding reference numerals indicate corresponding parts throughout the several views of the drawings.

### DETAILED DESCRIPTION

Example embodiments will now be described more fully with reference to the accompanying drawings.

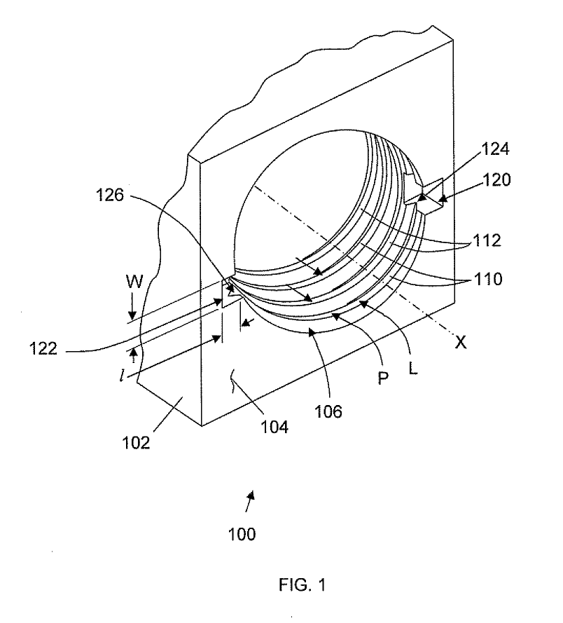

In the various embodiments of the present disclosure, a fluid flow apparatus is provided that is configured to be connected to a threaded fitting for communication of a fluid therethrough. According to one aspect of the present disclosure, the various embodiments of a fluid flow apparatus include an internally threaded hole configured to be connected to a threaded fitting in a manner such that the mating threaded fitting aligns with the internally threaded hole so that cross-threading is avoided. One embodiment of a fluid flow apparatus configured to receive a threaded fitting is shown as 100 in FIG. 1. The fluid flow apparatus 100 includes a housing or body 102 having an outer surface 104, and an internally threaded hole 106 in the outer surface 104 of the body 102.

The internally threaded hole 106 may have a number of start threads 110, 112, which have an associated thread lead distance ‘L’ and pitch ‘P’. The pitch ‘P’ is the distance from the crest of one thread to the next adjacent thread. The thread lead distance ‘L’ is the distance along the axis X of the internally threaded hole 106 that covers one complete coil or rotation of a start thread 110, which corresponds to one rotation of a threaded fitting (not shown) that may be received within the internally threaded hole 106. The internally threaded hole 106 may have multiple start threads or a single start thread. A single start thread means only one thread is helically coiled around the cylinder of the internally threaded hole 106, where each full rotation (360°) of a mating threaded fitting causes the fitting to advance axially the pitch width of one thread within the internally threaded hole 106. A single start thread also requires a full turn of a threaded fitting within the internally threaded hole 106 before the threads of the fitting completely engage the start thread in the internally threaded hole 106. A double start thread means that there are two start threads in parallel that are helically coiled around the cylinder of the internally threaded hole 106, where the distance between the first start thread and second start thread is the pitch, and the thread lead distance ‘L’ along the axis X that corresponds to one complete coil or rotation of one start thread is twice the pitch. Thus, each full rotation (360°) of a mating threaded fitting relative to a double start thread would cause the fitting to advance axially the pitch width of two threads (i.e., the thread lead distance). A double start thread also requires only a half-turn of a threaded fitting within the internally threaded hole 106 before the threads of the fitting completely engage the start threads of the internally threaded hole 106.

Threaded fittings, especially fittings having tapered ‘NPT’ pipe threads, can easily become misaligned with respect to a standard internally threaded hole in a fluid flow device, and can have a tendency to cross-thread. Cross-threading can lead to a compromised fit, and leakage of fluid at the fitting connection. To address this concern, the various embodiments comprise at least two slots 120, 122 in the outer surface 104 of the body 102, each of which extend to and intersect the internally threaded hole 106 in the outer surface 104. The at least two slots 120, 122 have a depth less than 1½ times the thread lead distance ‘L’ such that for each start thread 110, 112 only a first coil, wrap, turn or revolution of the start thread has a full threadform cross-section cut-away or exposed by the at least two slots 120, 122, which provides a lead-in notch 124, 126 configured to enable a mating threaded fitting to align with the internally threaded hole 106, as explained in the following description of the embodiments.

Referring to FIG. 1, the first embodiment of a fluid flow apparatus 100 includes a body 102 having an outer surface 104, and an internally threaded hole 106 in the outer surface 104 that has a number of start threads. The number of start threads include a first start thread 110 and a second start thread 112, and an associated thread lead distance L that is twice the pitch distance from the crest of one thread to the next. The fluid flow apparatus 100 includes at least two slots 120, 122 in the outer surface 104 of the body 102. Each of the at least two slots 120, 122 extend to and intersect the internally threaded hole 106. The at least two slots 120, 122 have a depth from the outer surface that is more than ½ the thread lead distance ‘L’ but less than 1½ times the thread lead distance ‘L’ associated with the first start thread 110 and second start thread 112. The slots 120, 122 accordingly have a depth such that for each start thread 110, 112, only a first coil or turn of the first start thread 110 has a full threadform cross-section exposed by the at least two slots 120, 122 and only a first coil or turn of the second start thread 112 has a full threadform cross-section exposed by the at least two slots 120, 122. Thus, the depth of the at least two slots 120, 122 thereby create only one fully exposed threadform for each of the start threads 110, 112, to provide first and second lead-in notches 124, 126 corresponding to the first and second start threads 110, 112. The first and second lead-in notches 124, 126 are configured to receive the start threads of a mating threaded fitting for enabling the threaded fitting to align with the internally threaded hole 106, such that cross-threading is avoided. The fluid flow apparatus 100 with at least two slots 120, 122 having a depth in the above specified range provides the advantages of increasing the speed of assembly without risk of cross-threading, while also exposing only one full threadform cross-section which reduces the risk of compromised thread engagement.

Additionally, the at least two slots 120, 122 extend a minimum length to the internally threaded hole 106, such that the length ‘l’ of the at least two slots 120, 122 is substantially insufficient to permit a tool to apply a rotational torque via the at least two slots 120, 122. Preferably, the at least two slots 120, 122 extend a length ‘l’ that is less than 1½ times the thread depth. The at least two slots may have a width ‘W’ that is a ratio of the thread lead distance ‘L’, where the ratio of the width ‘W’ to the thread lead distance ‘L’ is between 1:1 and 1:2 (the width ‘W’ is more than the thread lead distance ‘L’ but less than twice the thread lead distance ‘L’). The at least two slots 120, 122 may be disposed on diametrically opposite sides of the internally threaded hole 106 as shown in FIG. 1, or alternatively, the at least two slots 120, 122 may be disposed around the internally threaded hole 106 at locations other than diametrically opposite sides. While the embodiment shown in FIG. 1 includes double start threads, the internally threaded hole may include multiple start threads or any number of start threads, even a single start thread as in the following embodiment.

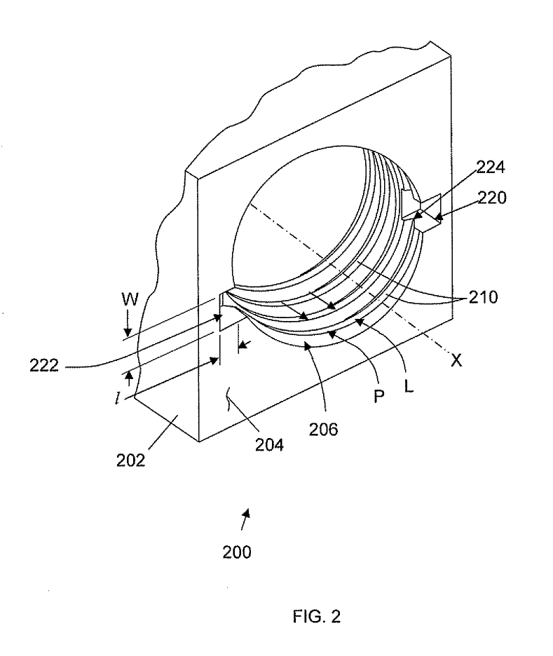

Referring to FIG. 2, a second embodiment of a fluid flow apparatus 200 is shown, which includes a body 202 having an outer surface 204, and an internally threaded hole 206 in the outer surface 204. The internally threaded hole 206 has a single start thread 210, with a thread lead distance ‘L’ and pitch ‘P’ associated with the start thread 210. The fluid flow apparatus 200 includes at least two slots 220, 222 in the outer surface 204 of the body 202. The at least two slots 220, 222 each extend to and/or intersect the internally threaded hole 206 in the outer surface 204. The at least two slots 220, 222 have a depth from the outer surface that is more than ½ the thread lead distance ‘L’ but less than 1½ times the thread lead distance ‘L’ such that only a first coil, wrap, turn or revolution of the single start thread 210 has a full threadform cross-section that is cut-away or exposed by the at least two slots 220, 222. The depth of the at least two slots 220, 222 expose only one full threadform to provide only one full lead-in notch 224 at one of the at least two slots 220, 222, which lead-in notch 224 is configured to receive a start thread of a mating threaded fitting for enabling the threaded fitting to align with the internally threaded hole 206, such that cross-threading is avoided. More preferably, the at least two slots 220, 222 have a depth from the outer surface 204 that is less than the thread lead distance ‘L’ but more than ½ the thread lead distance ‘L’ associated with the internally threaded hole 206. The fluid flow apparatus 200 with at least two slots 220, 222 having a depth in the above specified range provides the advantages of increasing the speed of assembly without risk of cross-threading, while also reducing the risk of compromised thread engagement.

In the second embodiment, the at least two slots 220, 222 extend a minimum length to the internally threaded hole 206, such that the length ‘l’ of the at least two slots 220, 222 is substantially insufficient to permit a tool to apply a rotational torque via the at least two slots 220, 222. Preferably, the at least two slots 220, 222 that extend to the internally threaded hole 206 have a length ‘l’ less than 1½ times the thread depth. The at least two slots 220, 222 may have a width ‘W’ that is a ratio of the thread lead distance ‘L’, where the ratio of the width ‘W’ to the thread lead distance ‘L’ is between 1:1 and 1:2. The at least two slots 220, 222 may be disposed on diametrically opposite sides of the internally threaded hole 206 as shown in FIG. 2, or alternatively, the at least two slots 220, 222 may be disposed around the internally threaded hole 206 at locations other than diametrically opposite sides. It should be noted that while only two slots 220, and 222 are shown in FIG. 2, the embodiment shown is not so limited, and the at least two slots 220, 222 may comprise at least three slots that extend to the internally threaded hole 206, and described below.

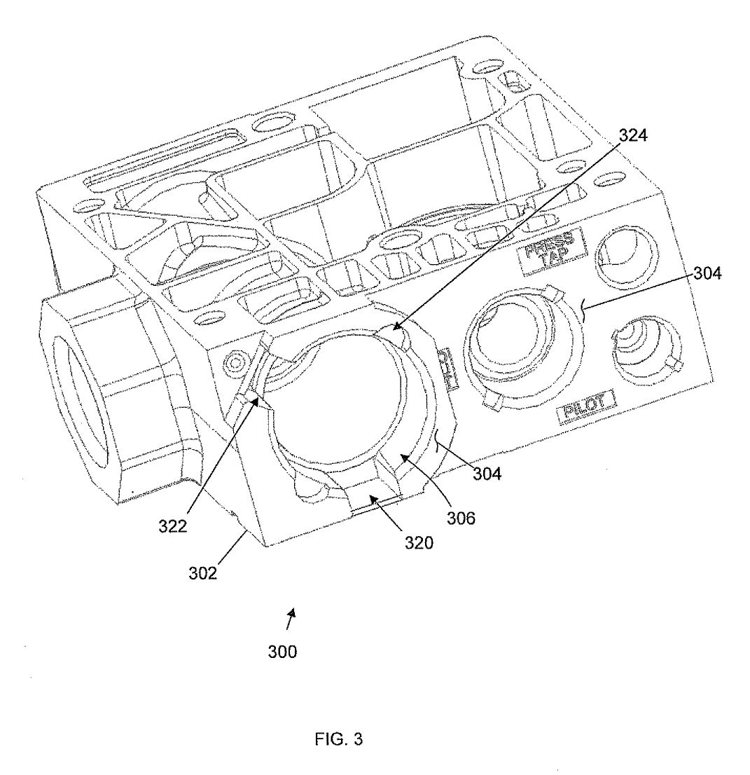

Referring to FIG. 3, a third embodiment of a fluid flow apparatus 300 is shown, which includes a body 302 having an outer surface 304, and an internally threaded hole 306 in the outer surface 304. The internally threaded hole 306 is similar to the internally threaded hole 206 in FIG. 2, and has a thread lead distance ‘L’ and pitch ‘P’. As in FIG. 2, the internally threaded hole 306 further includes at least three slots 320, 322, 324 in the outer surface 304 of the body 302. The at least three slots 320, 322, 324 each extend to and/or intersect the internally threaded hole 306 in the outer surface 304. The at least three slots 320, 322, 324 have a depth from the outer surface that is more than ½ the thread lead distance ‘L’ but less than 1½ times the thread lead distance ‘L’ associated with the internally threaded hole 306, such that only a first coil, wrap, turn or revolution of a single start thread of the internally threaded hole 306 has a full threadform cross-section that is cut-away or exposed. The depth of the at least three slots 320, 322, 324 creates only one fully exposed threadform to provide at least one notch configured to receive the start threads of a threaded fitting (not shown), for enabling the threaded fitting to align with the internally threaded hole 306 such that cross-threading is avoided.

In the third embodiment, the at least three slots 320, 322, 324 extend a minimum length to the internally threaded hole 306, such that the length ‘l’ of the at least three slots 320, 322, 324 is substantially insufficient to permit a tool to apply a rotational torque via the at least three slots 320, 322, 324. Preferably, the at least three slots 320, 322, 324 that extend to the internally threaded hole 306 have a length ‘l’ less than 1½ times the thread depth. The at least three slots 320, 322, 324 may have a width ‘W’ that is a ratio of the thread lead distance ‘L’, where the ratio of the width ‘W’ to the thread lead distance ‘L’ is between 1:1 and 1:2.

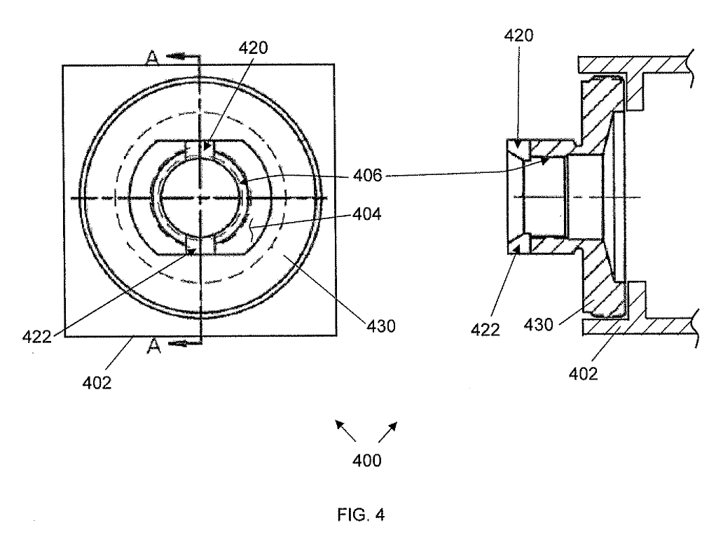

Referring to FIG. 4, a fourth embodiment of a fluid flow apparatus 400 is shown, which includes a body 402 having an outer surface 404. In the fourth embodiment, the fluid flow apparatus 400 includes an internally threaded hole 406 disposed in an insert 430 having outer surface 404, which insert 430 is secured in the body 402 of the fluid flow apparatus 400. The internally threaded hole 406 is similar to the internally threaded hole 206 in FIG. 2, and has a thread lead distance ‘L’ and pitch ‘P’. As in FIG. 2, the internally threaded hole 406 further includes at least two slots 420, 422 in the outer surface 404. The at least two slots 420, 422 each extend to and/or intersect the internally threaded hole 406 in the outer surface 404. The at least two slots 420, 422 have a depth from the outer surface that is more than ½ the thread lead distance ‘L’ but less than 1½ times the thread lead distance ‘L’ associated with the internally threaded hole 406, such that only a first coil, wrap, turn or revolution of a single start thread of the internally threaded hole 406 has a full threadform cross-section that is cut-away or exposed. The depth of the at least two slots 420, 422 creates only one fully exposed threadform to provide at least one notch configured to receive the start threads of a threaded fitting (not shown), for enabling the threaded fitting to align with the internally threaded hole 406 such that cross-threading is avoided.

In the fourth embodiment, the at least two slots 420, 422 extend a minimum length to the internally threaded hole 406, such that the length ‘l’ of the at least two slots 420, 422 is substantially insufficient to permit a tool to apply a rotational torque via the at least two slots 420, 422. Preferably, the at least two slots 420, 422 that extend to the internally threaded hole 406 have a length ‘l’ less than 1½ times the thread depth ‘D’. The at least two slots 420, 422 may have a width ‘W’ that is a ratio of the thread lead distance ‘L’, where the ratio of the width ‘W’ to the thread lead distance ‘L’ is between 1:1 and 1:2.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A fluid flow apparatus configured to receive a threaded fitting, comprising:
a body having an outer surface;
an internally threaded hole in the outer surface of the body, the internally threaded hole having a number of start threads and an associated thread lead distance;
at least two slots in the outer surface of the body, each of the at least two slots extending to and intersecting the internally threaded hole in the outer surface, wherein the at least two slots have a depth from the outer surface that is more than ½ the thread lead distance but less than 1½ times the thread lead distance, such that for each start thread only a first thread turn has a full threadform cross-section that is exposed by the at least two slots to provide a thread lead-in notch that is configured to enable a start thread of a mating threaded fitting to align with the internally threaded hole such that cross-threading is avoided.

2. The fluid flow apparatus of claim 1, wherein the at least two slots extend a minimum length to the internally threaded hole, such that the length of the at least two slots is substantially insufficient to permit a tool to apply a rotational torque via the at least two slots.

3. The fluid flow apparatus of claim 1, wherein the slots extending to the internally threaded hole have a length less than twice the thread depth.

4. The fluid flow apparatus of claim 1, wherein the at least two slots have a depth from the outer surface that is less than the thread lead distance but more than ½ the thread lead distance.

5. The fluid flow apparatus of claim 1, wherein the internally threaded hole has a single start thread, and only a first thread turn of the single start thread has a full threadform cross-section that is exposed by the at least two slots, to provide a thread lead-in notch at one of the at least two slots that is configured to enable a start thread of a mating threaded fitting to align with the internally threaded hole.

6. The fluid flow apparatus of claim 1, wherein the internally threaded hole has two start threads comprising a first start thread and a second start thread, and only a first thread turn of the first start thread has a full threadform cross-section exposed by the at least two slots, and only a first thread turn of the second start thread has a full threadform cross-section exposed by the at least two slots, to thereby provide first and second lead-in notches for each of the first and second start threads, which are configured to enable a start thread of a mating threaded fitting to align with the internally threaded hole.

7. The fluid flow apparatus of claim 1, wherein the at least two slots have a width that is a ratio of the thread lead distance, where the ratio of the width to the thread lead distance is between 1:1 and 1:2.

8. The fluid flow apparatus of claim 1, wherein the at least two slots are disposed on diametrically opposite sides of the internally threaded hole.

9. A fluid flow device adapted to receive a threaded fitting, comprising:
a body having an outer surface;
an internally threaded hole in the outer surface of the body, the internally threaded hole having two start threads including a first start thread and a second start thread, and an associated thread lead distance;
at least two slots in the outer surface of the body, each of the at least two slots extending to and intersecting the internally threaded hole in the outer surface, wherein the at least two slots have a depth from the outer surface that is more than ½ the thread lead distance but less than 1½ times the thread lead distance, such that for each start thread only a first thread turn of the first start thread has a full threadform cross-section exposed by the at least two slots, and only a first thread turn of the second start thread has a full threadform cross-section exposed by the at least two slots, to thereby provide first and second lead-in notches for each of the first and second start threads, which are configured to enable a start thread of a mating threaded fitting to align with the internally threaded hole such that cross-threading is avoided.

10. The fluid flow apparatus of claim 9, wherein the at least two slots comprise at least three slots that extend to the internally threaded hole.

11. The fluid flow apparatus of claim 9, wherein the slots extending to the internally threaded hole have a length less than twice the thread depth.

12. The fluid flow apparatus of claim 11, wherein the at least two slots have a width that is a ratio of the thread lead distance, where the ratio of the width to the thread lead distance is between 1:1 and 1:2.

13. A fluid flow apparatus configured to receive a threaded fitting, comprising:
a body having an outer surface;
an internally threaded hole in the outer surface of the body, the internally threaded hole having a single start thread and an associated thread lead distance;
at least two slots in the outer surface of the body, each of the at least two slots extending to the internally threaded hole in the outer surface, wherein the at least two slots have a depth from the outer surface that is more than ½ the thread lead distance but less than 1½ times the thread lead distance, such that only a first thread turn of the single start thread has a full threadform cross-section that is exposed by the at least two slots, to provide a thread lead-in notch at one of the at least two slots that is configured to enable to enable a start thread of a mating threaded fitting to align with the internally threaded hole such that cross-threading is avoided.

14. The fluid flow apparatus of claim 13, wherein the at least two slots extend a minimum length to the internally threaded hole, such that the length of the at least two slots is substantially insufficient to permit a tool to apply a rotational torque via the at least two slots.

15. The fluid flow apparatus of claim 13, wherein the at least two slots comprise at least three slots that extend to the internally threaded hole.

16. The fluid flow apparatus of claim 13, wherein the slots extending to the internally threaded hole have a length less than twice the thread depth.

17. The fluid flow apparatus of claim 16, wherein the at least two slots have a depth from the outer surface that is less than the thread lead distance but more than ½ the thread lead distance.

18. The fluid flow apparatus of claim 16, wherein the at least two slots have a width that is a ratio of the thread lead distance, where the ratio of the width to the thread lead distance is between 1:1 and 1:2.

19. The fluid flow apparatus of claim 16, wherein the at least two slots are disposed on diametrically opposite sides of the internally threaded hole.

20. The fluid flow apparatus of claim 16, wherein the at least two slots are disposed around the internally threaded hole at locations other than diametrically opposite sides of the internally threaded hole.
